(19) United States
(12) Patent Application Publication
(10) Pub. No.: US 2024/0357034 A1
(43) Pub. Date: Oct. 24, 2024

(54) INFORMATION PROCESSING APPARATUS HAVING SCREEN LOCK FUNCTION, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: YOSHIKAZU KAWAI, Tokyo (JP)

(21) Appl. No.: 18/636,964

(22) Filed: Apr. 16, 2024

(30) Foreign Application Priority Data
Apr. 24, 2023 (JP) 2023-070893

(51) Int. Cl. H04M 1/72463; G06F 3/041; G06F 3/0485; G06F 8/65; G06F 11/30; G06F 11/32; G11B 27/36

(52) U.S. Cl. CPC H04M 1/724634; G06F 3/0412; G06F 3/0485; G06F 8/65; G06F 11/302; G06F 11/328; G11B 27/36

(57) ABSTRACT

An information processing apparatus having a display unit. A check screen for checking a progress status of predetermined processing being executed by the information processing apparatus is displayed on the display unit. The information processing apparatus shifts to a locked state in which a user operation performed on the check screen is restricted. In a case where an instruction for shifting the information processing apparatus to the locked state is received from a user, the check screen on which a user operation is restricted is displayed on the display unit. On the check screen on which a user operation is restricted, the progress status of the predetermined processing is displayed on a real-time basis.

### BACKGROUND OF THE INVENTION

### Field of the Invention

The present invention relates to an information processing apparatus having a screen lock function, a method of controlling the information processing apparatus, and a storage medium.

### Description of the Related Art

For a mobile terminal, which is an example of an information processing apparatus, a user operation is frequently performed on a touch screen displayed thereon. Therefore, to prevent a user's erroneous touch on the touch screen from causing an unintended operation on the mobile terminal during execution of processing by the mobile terminal, the mobile terminal is equipped with a screen lock function. Even when the screen lock function is activated, the mobile terminal executes processing in the background and hence means is required for notifying the user of what kind of processing was executed during activation of the screen lock function. U.S. Pat. No. 10,365,794 has proposed a related art technique. In the technique described in U.S. Pat. No. 10,365,794, information notified from an application operating during activation of the screen lock function is displayed after the screen lock function is deactivated. With this, after the screen lock function is deactivated, a user can check what kind of processing has been executed during activation of the screen lock function.

However, in the technique described in U.S. Pat. No. 10,365,794, the information notified from the application operating during activation of the screen lock function is not displayed on a real-time basis. Therefore, conventionally, it is impossible to enable a user to check the progress status of processing being executed during activation of the screen lock function on a real-time basis while preventing a user's erroneous operation.

### SUMMARY OF THE INVENTION

The present invention provides an information processing apparatus that enables a user to check the progress status of processing being executed during activation of a screen lock function on a real-time basis while preventing a user's erroneous operation, a method of controlling the information processing apparatus, and a storage medium.

In a first aspect of the present invention, there is provided an information processing apparatus including a display unit, at least one processor; and a memory coupled to the at least one processor, the memory having instructions that, when executed by the processor, perform the operations as a control unit configured to cause a check screen for checking a progress status of predetermined processing being executed by the information processing apparatus, to be displayed on the display unit, and a lock unit configured to shift the information processing apparatus to a locked state in which a user operation performed on the check screen is restricted, wherein in a case where an instruction for shifting the information processing apparatus to the locked state is received from a user, the control unit causes the check screen on which a user operation is restricted to be displayed on the display unit, and wherein on the check screen on which a user operation is restricted, the progress status of the predetermined processing is displayed on a real-time basis.

In a second aspect of the present invention, there is provided a method of controlling an information processing apparatus including a display unit, including displaying a check screen for checking a progress status of predetermined processing being executed by the information processing apparatus on the display unit, shifting the information processing apparatus to a locked state in which a user operation performed on the check screen is restricted, and causing the check screen on which a user operation is restricted to be displayed on the display unit in a case where an instruction for shifting the information processing apparatus to the locked state is received from a user, wherein on the check screen on which a user operation is restricted, the progress status of the predetermined processing is displayed on a real-time basis.

According to the present invention, it is possible to enable a user to check the progress status of processing being executed during activation of the screen lock function on a real-time basis while preventing a user's erroneous operation.

Further features of the present invention will become apparent from the following description of exemplary embodiments (with reference to the attached drawings).

### BRIEF DESCRIPTION OF THE DRAWINGS

FIG. 1 is a diagram showing the configuration of a system including an information processing apparatus according to an embodiment of the present invention.

FIG. 2 is a block diagram schematically showing a hardware configuration of the information processing apparatus appearing in FIG. 1.

FIGS. 3A and 3B are diagrams each showing an example of a transfer screen displayed on a display when transfer processing is performed by an image transfer function.

FIG. 4 is a flowchart of a screen lock control process performed by the information processing apparatus appearing in FIG. 1.

FIGS. 5A to 5C are diagrams each showing an example of a transfer screen displayed on the display appearing in FIG. 2.

FIG. 6 is a flowchart of a variation of the screen lock control process performed by the information processing apparatus appearing in FIG. 1.

### DESCRIPTION OF THE EMBODIMENTS

The present invention will now be described in detail below with reference to the accompanying drawings showing embodiments thereof. The characteristic features of the present invention will be described using an example of a system including an information processing apparatus according to an embodiment of the present invention.

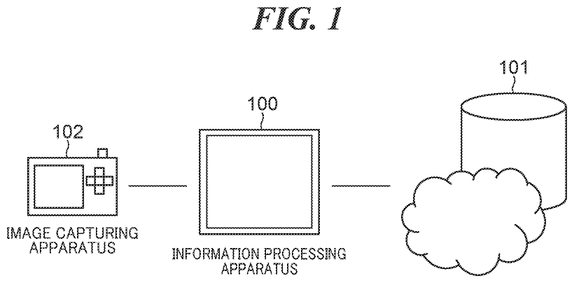

FIG. 1 is a diagram showing the configuration of the system including the information processing apparatus, denoted by reference numeral 100, according to the embodiment of the present invention. This system is comprised of the information processing apparatus 100, a server apparatus 101, and an image capturing apparatus 102.

The information processing apparatus 100 is a mobile terminal, such as a smartphone or a tablet terminal, or a personal computer. The server apparatus 101 is a server system that makes it possible to store and share photograph data on a network. The photograph data is still image data and moving image data, generated, for example, by the image capturing apparatus 102 that photographs an object. The image capturing apparatus 102 is, for example, a digital camera.

The information processing apparatus 100 is communicably connected to the image capturing apparatus 102, for example, by a wired cable or is capable of wirelessly communicating with the image capturing apparatus 102. Further, the information processing apparatus 100 can communicate with the server apparatus 101 via a communication device, such as a wireless router, a modem, and a communication base station.

The information processing apparatus 100 is equipped with a screen lock function for preventing an unintended operation from being performed due to a user's erroneous touch on a touch screen displayed on the information processing apparatus 100 during execution of processing. Note that in the information processing apparatus 100, even when the screen lock function is activated, processing is executed in the background.

Further, the information processing apparatus 100 is equipped with an image transfer function for transferring photograph data received from a camera to a server. In this image transfer function, first, the information processing apparatus 100 receives device information of the image capturing apparatus 102 and information on photograph data stored in a storage medium of the image capturing apparatus 102, from the image capturing apparatus 102. Further, the information processing apparatus 100 communicates with the server apparatus 101 and performs authentication processing necessary for transferring the photograph data. Then, the information processing apparatus 100 determines, based on a transfer condition set in advance, whether to transfer all photograph data stored in the storage medium of the image capturing apparatus 102 or only part of a plurality of photograph data stored in the storage medium. The part of the photograph data is, for example, photograph data identified based on metadata of each photograph data stored in the storage medium of the image capturing apparatus 102 such that the photograph data includes predetermined data. The information processing apparatus 100 acquires photograph data to be transferred from the image capturing apparatus 102 based on a result of the determination and stores the acquired photograph data. After that, the information processing apparatus 100 transfers the stored photograph data to the server apparatus 101.

The above-described image transfer function is used, for example, when a photographer on site transmits photograph data generated by photographing performed using the image capturing apparatus 102 to the server apparatus 101 in his/her company via the information processing apparatus 100. In a case where the image transfer function is used for such a business use, the screen lock function is used at the same time so as to prevent erroneous transmission of the photograph data, caused by an erroneous operation on the image forming apparatus.

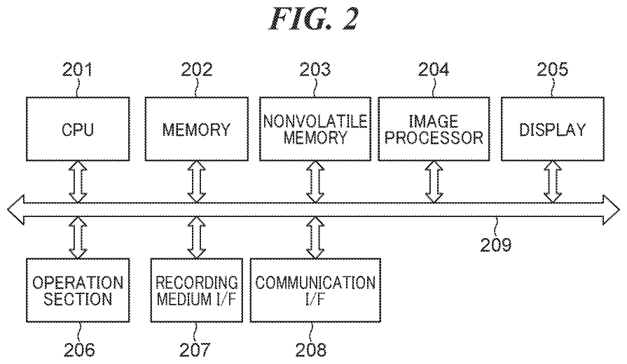

FIG. 2 is a block diagram schematically showing a hardware configuration of the information processing apparatus 100 appearing in FIG. 1. Referring to FIG. 2, the information processing apparatus 100 includes a central processing unit (CPU) 201, a memory 202, a nonvolatile memory 203, an image processor 204, a display 205, an operation section 206, a recording medium interface (I/F) 207, and a communication I/F 208. These components can send and receive data to and from each other via an internal bus 209.

The CPU 201 controls the overall operation of the information processing apparatus 100. For example, the CPU 201 controls the components of the information processing apparatus 100 according to programs stored in the nonvolatile memory 203 by using the memory 202 as a work area. The memory 202 is implemented, for example, by a random access memory (RAM), and includes the work area for the CPU 201, an area for saving data when error processing is executed, an area for loading a control program, and so forth. The nonvolatile memory 203 is implemented, for example, by a read only memory (ROM). The nonvolatile memory 203 stores a variety of control programs for the operation of the CPU 201 and data.

The image processor 204 performs a variety of image processing operations on photograph data stored in the nonvolatile memory 203, or photograph data acquired via the recording medium I/F 207 or the communication I/F 208 under the control of the CPU 201. The image processing operations performed by the image processor 204 include, for example, A/D conversion processing, D/A conversion processing, processing for encoding photograph data, compression processing, decoding processing, enlargement/reduction processing, noise reduction processing, and color conversion processing. Note that the image processor 204 can be formed by a dedicated circuit block for performing predetermined image processing. Further, the predetermined image processing can be executed by the CPU 201 according to a program without using the image processor 204.

The display 205 displays, for example, an image, an icon, a message, a menu, and other graphical user interface (GUI) screens under the control of the CPU 201. Note that in the present embodiment, the display 205 can be externally attached to the information processing apparatus 100. In this configuration, the information processing apparatus 100 includes an interface for outputting video signals to the external display 205 to display an image or the like on the display 205.

The operation section 206 is an input device for receiving a user operation. The operation section 206 is comprised, for example, of a character information input device, such as a keyboard, a pointing device, such as a mouse, buttons, a dial, a joystick, a touch sensor, and a touch panel. Note that the touch panel can be any of a resistance film type, an electrostatic capacitance type, a surface acoustic wave type, an infrared type, an electromagnetic induction type, an image recognition type, and an optical sensor type. In the present embodiment, in a case where the operation section 206 is a touch panel, a user operation performed on a display screen of the display 205 and coordinate information indicating a position where the user has touched are output from the touch panel to the CPU 201. The CPU 201 determines what kind of operation has been performed on the touch panel based on the acquired information.

The storage medium I/F 207 can attach thereto an external recording medium, such as a memory card, a hard disk, a compact disc (CD), and a digital versatile disc (DVD). The storage medium I/F 207 performs processing for reading data from the attached recording medium and processing for writing data into the attached recording medium under the control of the CPU 201.

The communication I/F 208 is connected to an external apparatus and the Internet by a wired cable or by wireless communication, for transmitting and receiving a variety of data, including photograph data, voice signals, a file, and a command. Note that the information processing apparatus 100 can include a plurality of communication I/Fs which are different in communication method. For example, out of the plurality of communication I/Fs, the information processing apparatus 100 uses a universal serial bus (USB) I/F for data communication with the image capturing apparatus 102 and another communication I/F capable of performing wireless communication for data communication with the server apparatus 101.

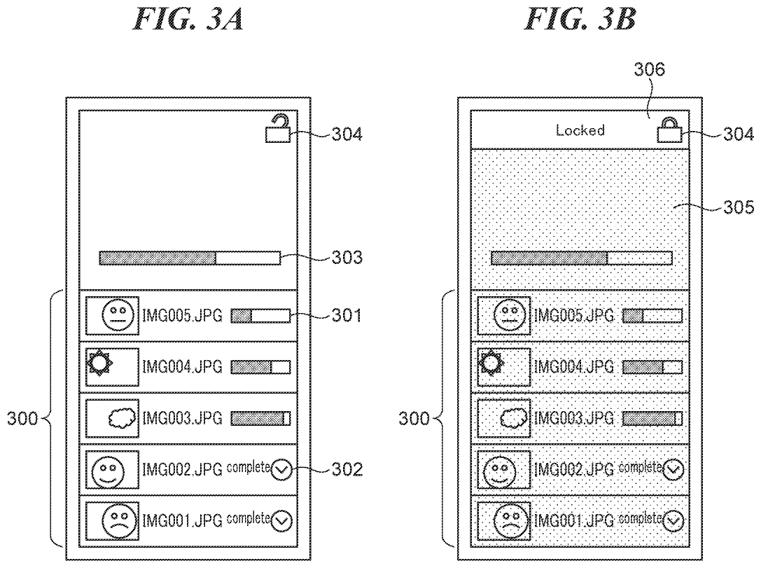

FIGS. 3A and 3B are diagrams each showing an example of a transfer screen displayed on the display 205 when transfer processing is performed by the image transfer function. FIG. 3A shows an example of a transfer screen displayed in a case where the screen lock function is set to be deactivated.

On the transfer screen shown in FIG. 3A, a transfer status list 300, a progress bar 303, and a screen lock icon 304 are displayed.

The transfer status list 300 is a list of progress status information of transfer tasks of the information processing apparatus 100 that receives photograph data from the image capturing apparatus 102 and transfers the received photograph data to the server apparatus 101. The transfer status list 300 displays a thumbnail, a file name, and a progress bar 301, as the progress status information of each transfer task. On the transfer status list 300, the progress status information of a transfer task associated with one of a plurality of photograph data to be transferred, which was most recently started to be transmitted from the image capturing apparatus 102, is displayed in the highest position. Note that in a case where the progress status information items of all transfer tasks cannot be displayed in the area of the transfer status list 300, a user can perform a scroll operation to view the progress status information of a transfer task transferred in the past and check the progress status information of a transfer task in a transfer waiting state.

The progress bar 301 is information indicating the progress status of a transfer task. For example, the progress bar 301 is information indicating the present progress status, by setting a time period required from the start of reception of photograph data from the image capturing apparatus 102 to completion of transfer of the received photograph data to the server apparatus 101 as 100%. Note that the display form of the progress bar 301 is not limited to the form illustrated in FIG. 3A, but for example, the progress status of reception of photograph data from the image capturing apparatus 102 and the progress status of transfer of the photograph data to the server apparatus 101 can be separately displayed.

Further, as the information indicating the progress status of a transfer task completed in transfer to the server apparatus 101, a transfer completion notification 302 is displayed in place of the progress bar 301. With this, the user can check which of the photograph data has been transferred at a glance.

The progress bar 303 is information indicating the progress status of the whole transfer processing performed by the image transfer function. For example, the progress bar 303 is information indicating a ratio of photograph data completely transferred to the server apparatus 101 to all photograph data to be transferred. Note that the display form of the progress bar 303 is not limited to the form illustrated in FIG. 3A, but for example, information indicating a ratio of photograph data completely received from the image capturing apparatus 102 and information indicating a ratio of photograph data completely transferred to the server apparatus 101 can be separately displayed.

The screen lock icon 304 is used to instruct the information processing apparatus 100 to shift to a locked state for restricting a user operation on a screen displayed on the display 205. In FIG. 3A, the screen lock icon 304 is displayed in a shape indicating that the screen lock function is deactivated. In a deactivated state of the screen lock function shown in FIG. 3A, when a user touches the screen lock icon 304 on the transfer screen, the screen lock function of the information processing apparatus 100 is set to be activated, whereby the information processing apparatus 100 shifts to the locked state.

When the information processing apparatus 100 shifts to the locked state, a transfer screen shown in FIG. 3B, on which a user operation is restricted, is displayed on the display 205. On the transfer screen shown in FIG. 3B, the transfer status list 300 is displayed without any change from the progress status information items of the transfer tasks displayed immediately before the information processing apparatus 100 shifts to the locked state. On the transfer status list 300 on the transfer screen shown in FIG. 3B, the progress bars 301 and the progress bars 303 are updated on a real-time basis based on the degree of progress of the transfer processing performed by the image transfer function.

Further, on the transfer screen shown in FIG. 3B, the shape of the screen lock icon 304 is changed to a shape indicating that the screen lock function is activated. Further, on the transfer screen shown in FIG. 3B, an operation inhibited area 305 where a user operation is not received is displayed in a grayed-out state. On the transfer screen shown in FIG. 3B, a user operation can be received is only an unlocking area 306 including the screen lock icon 304.

The unlocking area 306 is for receiving an instruction for releasing the locked state. When the user touches the unlocking area 306, the screen lock function of the information processing apparatus 100 is set to be deactivated, whereby the information processing apparatus 100 shifts to an unlocked state. Note that in the present embodiment, as shown in FIG. 3B, the unlocking area 306 is formed as an area larger than the area of the screen lock icon 304. With this, it is possible to enhance the operability when the user sets the screen lock function to the deactivated state.

Note that in the present embodiment, an operation time associated with the instruction for shifting the information processing apparatus 100 to the locked state and an operation time associated with the instruction for releasing the locked state can be differentiated. Here, for example, even when the user erroneously instructs shifting to the locked state, a critical inconvenience, such as unintended start of transfer of photograph data or interruption of any of the transfer tasks being in progress, is not caused. Further, the area of the screen lock icon 304 for instructing shifting to the locked state is relatively small. Therefore, the operation time associated with the instruction for shifting the information processing apparatus 100 to the locked state is set to be short, giving the priority to enhancement of the operability. For example, shifting to the locked state is instructed by short-pressing of the screen lock icon 304.

On the other hand, in a case where the user erroneously instructs the information processing apparatus 100 to release the locked state, a critical inconvenience, such as unintended start of transfer of photograph data or interruption of any of the transfer tasks in progress, can be caused. Further, the unlocking area 306 for instructing release of the locked state is larger than the area of the screen lock icon 304, and there is a high possibility that the user erroneously operates the unlocking area 306. Therefore, the operation time associated with the instruction for releasing the locked state is set to be long, giving the priority to prevention of a user's erroneous operation. For example, the instruction for releasing the locked state is provided by long-pressing of the unlocking area 306. With this control, it is possible to reduce a situation that the locked state is erroneously released while enhancing the operability when shifting the information processing apparatus 100 to the locked state.

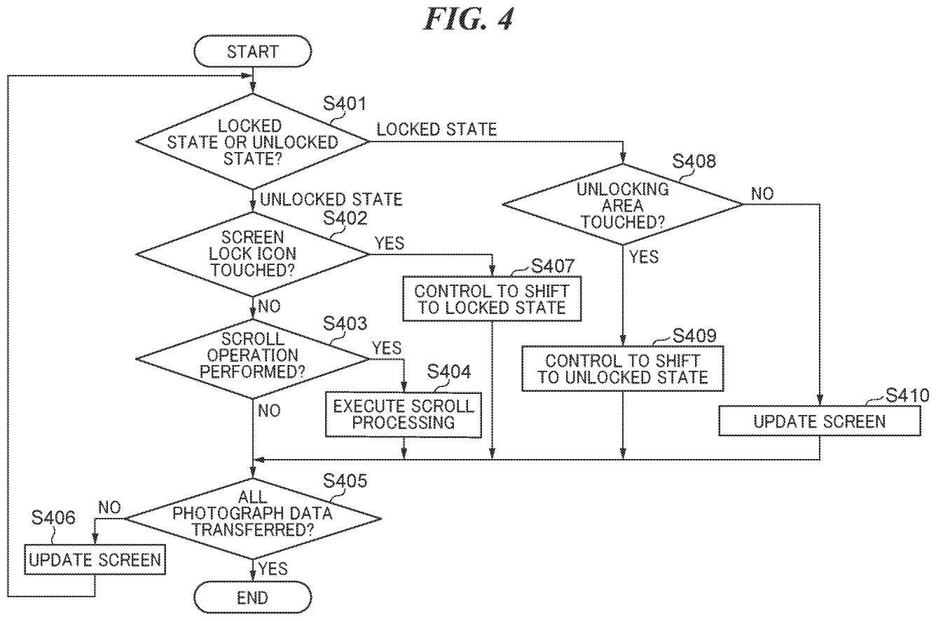

FIG. 4 is a flowchart of a screen lock control process performed by the information processing apparatus 100 appearing in FIG. 1. The screen lock control process in FIG. 4 is realized by the CPU 201 executing a program stored in the nonvolatile memory 203 or the like. The screen lock control process in FIG. 4 is executed, for example, when the information processing apparatus 100 receives an instruction for executing transfer processing of the image transfer function from a user. Note that in the screen lock control process in FIG. 4, it is assumed that the information processing apparatus 100 has received an instruction from the user, for executing transfer processing for transferring a plurality of photograph data using the image transfer function.

Referring to FIG. 4, first, in a step S401, the CPU 201 determines whether the information processing apparatus 100 is in the locked state or the unlocked state. If it is determined in the step S401 that the information processing apparatus 100 is in the unlocked state, the screen lock control process proceeds to a step S402. Note that at this time, the transfer screen shown in FIG. 3A is displayed on the display 205.

In the step S402, the CPU 201 determines whether or not the user has touched the screen lock icon 304 on the transfer screen shown in FIG. 3A. If it is determined in the step S402 that the user has not touched the screen lock icon 304, the screen lock control process proceeds to a step S403.

In the step S403, the CPU 201 determines whether or not the user has performed the operation of scrolling the transfer status list 300 on the transfer screen shown in FIG. 3A. If it is determined in the step S403 that the user has performed the operation of scrolling the transfer status list 300, the screen lock control process proceeds to a step S404.

In the step S404, the CPU 201 performs scroll processing according to an operation amount of the scroll operation detected in the step S403. With the scroll processing, the progress status information of the transfer tasks displayed on the transfer status list 300 is changed according to the operation amount of the scroll operation detected in the step S403. Thus, in the present embodiment, by performing a scroll operation in the unlocked state, the user can view the state of transferred data in the past and check the state of data to be transferred. Then, the screen lock control process proceeds to a step S405.

If it is determined in the step S403 that the user has not performed the operation of scrolling the transfer status list 300, the screen lock control process proceeds to the step S405 without performing the above-described scroll processing.

In the step S405, the CPU 201 determines whether or not all photograph data to be transferred have been completely transferred to the server apparatus 101. If it is determined in the step S405 that all photograph data to be transferred have been completely transferred to the server apparatus 101, the screen lock control process is terminated. If it is determined in the step S405 that any of the photograph data to be transferred has not been completely transferred to the server apparatus 101, the screen lock control process proceeds to a step S406.

In the step S406, the CPU 201 updates the transfer screen shown in FIG. 3A based on the degree of progress of the transfer processing performed by the image transfer function. For example, the progress bar 301 indicating the progress status of each transfer task and the progress bar 303 indicating the progress status of the whole transfer processing performed by the image transfer function are updated in accordance with the degree of progress of the transfer processing performed by the image transfer function. Further, as the progress status information of any transfer task completed in transfer to the server apparatus 101, the progress bar 301 is changed to the transfer completion notification 302. After that, the screen lock control process returns to the step S401.

If it is determined in the step S402 that the user has touched the screen lock icon 304, the screen lock control process proceeds to a step S407.

In the step S407, the CPU 201 performs control to shift the information processing apparatus 100 to the locked state. Specifically, the CPU 201 sets the screen lock function to the activated state and shifts the information processing apparatus 100 to the locked state. When the information processing apparatus 100 shifts to the locked state, the transfer screen shown in FIG. 3B, on which a user operation is restricted, is displayed on the display 205. On the transfer screen shown in FIG. 3B, an area other than the unlocking area 306, specifically, the operation inhibited area 305 displayed in the grayed-out state is disabled to receive a user operation. After that, the screen lock control process proceeds to the step S405.

If it is determined in the step S401 that the information processing apparatus 100 is in the locked state, the screen lock control process proceeds to a step S408.

In the step S408, the CPU 201 determines whether or not the user has touched the unlocking area 306 on the transfer screen shown in FIG. 3B. If it is determined in the step S408 that the user has touched the unlocking area 306, the screen lock control process proceeds to a step S409.

In the step S409, the CPU 201 performs control to shift the information processing apparatus 100 to the unlocked state. Specifically, the CPU 201 sets the screen lock function to the deactivated state and shifts the information processing apparatus 100 to the unlocked state. When the information processing apparatus 100 shifts to the unlocked state, the transfer screen shown in FIG. 3A, on which a user operation is not restricted, is displayed on the display 205. After that, the screen lock control process proceeds to the step S405.

If it is determined in the step S408 that the user has not touched the unlocking area 306, the screen lock control process proceeds to a step S410. In the step S410, the CPU 201 updates the transfer screen shown in FIG. 3B based on the degree of progress of the transfer processing performed by the image transfer function. For example, the progress bar 301 indicating the progress status of each transfer task and the progress bar 303 indicating the progress status of the whole transfer processing performed by the image transfer function are updated in accordance with the degree of progress of the transfer processing performed by the image transfer function. Further, as the progress status information of any transfer task completed in transfer to the server apparatus 101, the progress bar 301 is changed to the transfer completion notification 302.

Further, the progress status information of a transfer task associated with photograph data started to be received from the image capturing apparatus 102 is displayed in the highest position of the transfer status list 300. Here, the user is required to perform a scroll operation on the transfer screen to check the progress status information of the transfer tasks, and if the information processing apparatus 100 shifts to the locked state and a user operation is restricted on this transfer screen, the user is disabled to check the progress status information of the transfer tasks. To solve this problem, in the present embodiment, in a case where execution of one transfer task is started in a state in which the transfer screen shown in FIG. 3B is displayed on the display 205, the progress status information of the one transfer task is displayed in the highest position of the transfer screen shown in FIG. 3B. With this, even when a user operation is restricted with respect to the transfer screen requiring a scroll operation to check the progress status information of the transfer tasks, the user is enabled to check the progress status information of transfer tasks including the transfer task started most recently, on a real-time basis. After that, the screen lock control process proceeds to the step S405.

According to the above-described embodiment, in a case where it is determined that the user has touched the screen lock icon 304, the transfer screen shown in FIG. 3B, on which a user operation is restricted, is displayed on the display 205. On the transfer screen shown in FIG. 3B, the progress status of the transfer processing performed by the image transfer function is displayed on a real-time basis. This enables the user to check the progress status of processing being executed during activation of the screen lock function on a real-time basis while preventing a user's erroneous operation.

Further, in the above-described embodiment, the transfer processing performed by the image transfer function includes a plurality of tasks. This enables the user to check the progress statuses of the plurality of tasks being executed during activation of the screen lock function on a real-time basis.

Further, in the above-described embodiment, the tasks are tasks of data communication with a plurality of external apparatuses. This enables the user to check the progress status of tasks being executed during activation of the screen lock function for data communication with the plurality of external apparatuses, on a real-time basis.

Further, in the above-described embodiment, each task is a transfer task performed by the information processing apparatus 100 for receiving photograph data, generated through photographing by the image capturing apparatus 102, from the image capturing apparatus 102, and transferring the received photograph data to the server apparatus 101. This enables the user to check the progress status of a transfer task being executed during activation of the screen lock function on a real-time basis.

The present invention has been described using the above-described embodiment but is not limited to the above-described embodiment. For example, the progress status information of a transfer task displayed by a user's scroll operation before the information processing apparatus 100 shifts to the locked state can be controlled to be continuously displayed even after the information processing apparatus 100 shifts to the locked state.

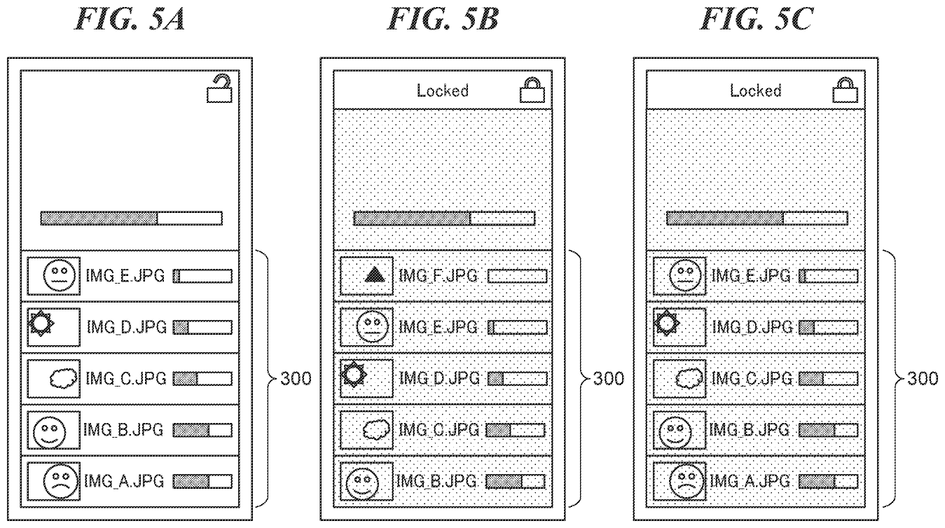

For example, let it be assumed that a user has performed a scroll operation so as to display the progress status information of a transfer task, on which the user desires to check the transfer status, on the transfer status list 300, and the progress status information items of transfer tasks A to E are displayed as shown in FIG. 5A before the user shifts the information processing apparatus 100 to the locked state. In a case where this operation has been performed, it is preferable, from a viewpoint of the usability, to display the progress status information items of the transfer tasks A to E even after the information processing apparatus 100 shifts to the locked state until all of the transfer tasks A to E are completed. However, in the above-described screen lock control process, when the information processing apparatus 100 shifts to the locked state and starts to receive photograph data corresponding to a transfer task F from the image capturing apparatus 102, the progress status information of the transfer task F is displayed in the highest position of the transfer status list 300 as shown in FIG. 5B. As a result, the progress status information of the transfer task A is no longer displayed, and the user is disabled to check the progress status of the transfer task A.

To solve this problem, in the present embodiment, the progress status information of the transfer task, displayed by a user's scroll operation before the information processing apparatus 100 shifts to the locked state, is controlled to be continuously displayed even after the information processing apparatus 100 shifts to the locked state.

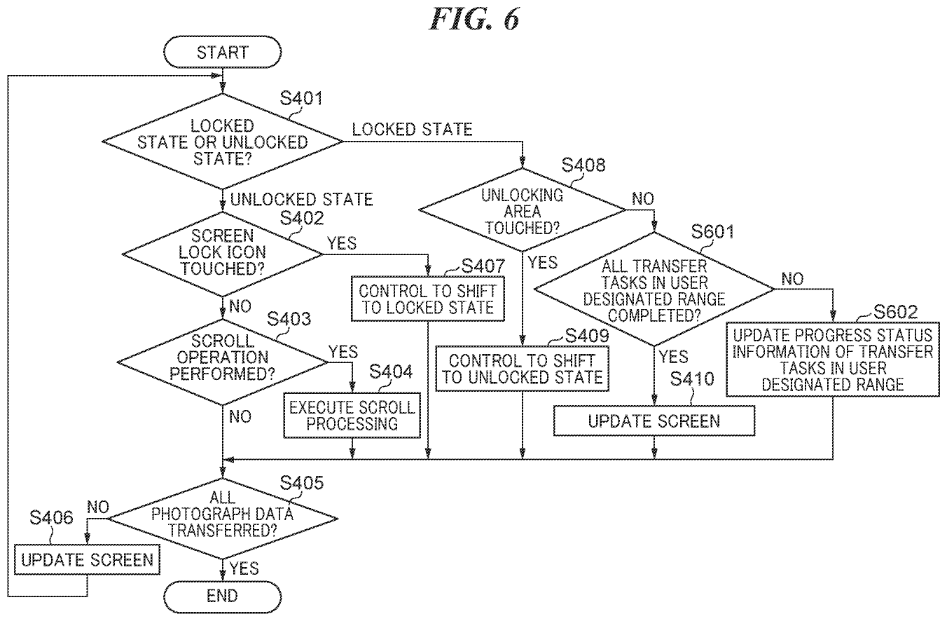

FIG. 6 is a flowchart of a variation of the screen lock control process performed by the information processing apparatus 100 appearing in FIG. 1. Note that the variation of the screen lock control process in FIG. 6 is a process similar to the above-described screen lock control process in FIG. 4, and the same processing operations are denoted by the same step numbers as those of the screen lock control process in FIG. 4, and the description will be given mainly of different processing operations from the screen lock control process in FIG. 4. Similar to the screen lock control process in FIG. 4, the screen lock control process in FIG. 6 is realized by the CPU 201 executing a program stored in the nonvolatile memory 203 or the like. Further, similar to the screen lock control process in FIG. 4, the screen lock control process in FIG. 6 is also executed, for example, when the information processing apparatus 100 receives an instruction for executing transfer processing using the image transfer function from a user. Note that, similar to the screen lock control process in FIG. 4, also in the screen lock control process in FIG. 6, it is assumed that the information processing apparatus 100 has received an instruction from the user, for executing transfer processing for transferring a plurality of photograph data using the image transfer function.

Referring to FIG. 6, first, the step S401 to S408 are executed.

If it is determined in the step S408 that the user has touched the unlocking area 306, the screen lock control process proceeds to the step S409 and then proceeds to the step S405. If it is determined in the step S408 that the user has not touched the unlocking area 306, the screen lock control process proceeds to a step S601.

In the step S601, the CPU 201 determines whether or not all of the transfer tasks in a user designated range have been completed. The user designated range is an area displayed on the progress status list 300 by a user's scroll operation performed before the information processing apparatus 100 shifts to the locked state. In the present embodiment, it is assumed that the user has performed the scroll operation so as to display the progress status information of the transfer tasks A to E on the transfer status list 300 as shown in FIG. 5A before the information processing apparatus 100 shifts to the locked state. When the information processing apparatus 100 shifts to the locked state in this display state, a transfer screen shown in FIG. 5C, on which a user operation is restricted, is displayed on the display 205. On the transfer status list 300 on this transfer screen, the progress status information items of the transfer tasks A to E are displayed.

If it is determined in the step S601 that any of the transfer tasks in the user designated range has not been completed, the screen lock control process proceeds to a step S602. In the step S602, the CPU 201 updates the progress status information of the transfer tasks in the user designated range. For example, the CPU 201 updates the progress bar 301 in accordance with the degree of progress of each transfer task in the user designated range. Further, the CPU 201 switches the progress bar 301 of each transfer task having completed in transfer to the server apparatus 101 to the transfer completion notification 302 as the progress status information. Further, the CPU 201 updates the progress bar 303 in accordance with the degree of progress of the transfer processing performed by the image transfer function. Thus, in the present embodiment, the display of the progress status information of the transfer tasks in the user designated range is continued on the transfer status list 300 until the transfer processing for all of the photograph data in the user designated range is completed. After execution of the step S602, the screen lock control process proceeds to the step S405.

If it is determined in the step S601 that all of the transfer tasks in the user designated range have been completed, the screen lock control process proceeds to the step S410. For example, in the step S410, the progress status information of a transfer task associated with photograph data started to be received from the image capturing apparatus 102 is displayed in the highest position of the transfer status list 300 (see, for example, FIG. 5B). Thus, in the present embodiment, in the locked state, after all of the transfer tasks in the user designated range have been completed, the user is enabled to check the progress status of a transfer task or transfer tasks started after the information processing apparatus 100 has shifted to the locked state. After execution of the step S410, the screen lock control process proceeds to the step S405.

In the above-described embodiment, the progress status information of transfer tasks, displayed by a user's scroll operation before the information processing apparatus 100 shifts to the locked state, is continuously displayed after the information processing apparatus 100 shifts to the locked state. This enables the user to check the progress status information of transfer tasks, displayed by the user's scroll operation before the information processing apparatus 100 shifts to the locked state, even after the information processing apparatus 100 shifts to the locked state.

Note that in the present embodiment, the display of the progress status information of a completed transfer task updated in a lower section can be performed by scroll animation. With this, the user can easily visually recognize the completed transfer task.

Further, in the present embodiment, in a case where a user's scroll operation is not received before a predetermined time period elapses after the transfer screen shown in FIG. 3A, on which a user operation is not restricted, is displayed, the progress status information of a transfer task which has been newly started can be displayed in the highest position of the transfer screen. This enables a user to check the progress status information of the newly started transfer task without forcing the user to perform a scroll operation in the unlocked state.

Further, in the present embodiment, the transfer status list 300 on the transfer screen in the locked state can display only part of the progress status information items of the transfer tasks displayed on the transfer status list 300 on the transfer screen in the unlocked state. For example, the transfer status list 300 on the transfer screen in the locked state can be controlled not to display the progress status information of the completed transfer task(s). Further, in a case where the progress status information of, for example, five transfer tasks at maximum can be displayed on the transfer status list 300 on the transfer screen in the unlocked state, the transfer status list 300 on the transfer screen in the locked state can be controlled to display only the progress status information of a smaller number of transfer tasks, than five, for example, only the progress status information of three transfer tasks. This makes it possible to reduce a processing load of the CPU in the locked state.

Note that although in the present embodiment, the information processing apparatus 100 performs the above-described screen lock control process in FIG. 4 or FIG. 6 when executing the transfer processing by the image transfer function, this is not limitative. For example, the information processing apparatus 100 can perform the screen lock control process in FIG. 4 or the variation of this process in FIG. 6 when the information processing apparatus 100 executes predetermined processing including a plurality of tasks of data communication with one or more external apparatuses.

The tasks included in the predetermined processing are not only the above-described transfer task, but also, for example, a task which receives data from an external apparatus, a task which transmits data to an external apparatus, or a task which updates a software module in the information processing apparatus 100 based on update data received from an external apparatus. On the screen for checking the progress statuses of these tasks, the user is also required to perform a scroll operation to check the progress statuses, and if the information processing apparatus 100 shifts to the locked state to restrict the user operation on this screen, the user cannot check the progress statuses of these tasks. To solve this problem, by performing the above-described screen lock control process in FIG. 4 or FIG. 6 when the information processing apparatus 100 executes the predetermined processing including the above-mentioned tasks, the user is enabled to check the progress statuses of these tasks on a real-time basis even after the information processing apparatus 100 has shifted to the locked state.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-070893 filed Apr. 24, 2023, which is hereby incorporated by reference herein in its entirety.

What is claimed is:

1. An information processing apparatus comprising:
a display unit;
at least one processor; and
a memory coupled to the at least one processor, the memory having instructions that, when executed by the processor, perform the operations as:
a control unit configured to cause a check screen for checking a progress status of predetermined processing being executed by the information processing apparatus, to be displayed on the display unit; and
a lock unit configured to shift the information processing apparatus to a locked state in which a user operation performed on the check screen is restricted,
wherein in a case where an instruction for shifting the information processing apparatus to the locked state is received from a user, the control unit causes the check screen on which a user operation is restricted to be displayed on the display unit, and
wherein on the check screen on which a user operation is restricted, the progress status of the predetermined processing is displayed on a real-time basis.

2. The information processing apparatus according to claim 1, wherein a first area for receiving an instruction for shifting the information processing apparatus to the locked state is displayed on the check screen,
wherein a second area for receiving an instruction for releasing the locked state is displayed on the check screen on which a user operation is restricted, and
wherein the second area is larger than the first area.

3. The information processing apparatus according to claim 2, wherein an operation time associated with the instruction for releasing the locked state is longer than an operation time associated with the instruction for shifting the information processing apparatus to the locked state.

4. The information processing apparatus according to claim 1, wherein the display unit is formed by a touch panel.

5. The information processing apparatus according to claim 1, wherein the predetermined processing includes a plurality of tasks.

6. The information processing apparatus according to claim 5, wherein the plurality of tasks included in the predetermined processing are tasks that perform data communication with a plurality of external apparatuses.

7. The information processing apparatus according to claim 6, wherein the plurality of tasks that perform data communication with the plurality of external apparatuses each are a task that receives photograph data generated by photographing performed by an image capturing apparatus from the image capturing apparatus and transfers the received photograph data to a server.

8. The information processing apparatus according to claim 5, wherein the plurality of tasks included in the predetermined processing are tasks that perform data communication with one or more external apparatuses.

9. The information processing apparatus according to claim 8, wherein the tasks that perform data communication with the one or more external apparatuses include a task that receives photograph data generated by photographing performed by an image capturing apparatus from the image capturing apparatus and transfers the received photograph data to a server, a task that receives data from an external apparatus, a task that transmits data to an external apparatus, and a task that updates a software module in the information processing apparatuses based on update data received from an external apparatus.

10. The information processing apparatus according to claim 1, wherein in a case where execution of one task is started in a state in which the check screen on which a user operation is restricted is displayed on the display unit, the control unit causes information on the progress status of the one task to be displayed in the highest position of the check screen on which a user operation is restricted.

11. The information processing apparatus according to claim 1, wherein on the check screen on which a user operation is restricted, there is displayed part of information displayed on the check screen before the information processing apparatus shifts to the locked state.

12. The information processing apparatus according to claim 5, wherein in a case where an instruction for shifting the information processing apparatus to the locked state is received from a user, the control unit causes, out of information items of progress statuses of the plurality of tasks included in the predetermined processing, information items of progress statuses of tasks designated by a scroll operation performed by the user before the information processing apparatus shifts to the locked state, to be displayed on the check screen on which a user operation is restricted, and the information items of the progress statuses of the tasks designated by the scroll operation are displayed on the check screen on which a user operation is restricted until all of the tasks designated by the scroll operation are completed.

13. The information processing apparatus according to claim 5, wherein on the check screen, information on a progress status of a task which cannot be displayed on the check screen is displayed according to a scroll operation performed by a user.

14. The information processing apparatus according to claim 5, wherein in a case where a user's scroll operation is not received before a predetermined time period elapses after the check screen is displayed on the display unit, the control unit causes information of a progress status of a task started to be executed to be displayed in the highest position of the check screen.

15. A method of controlling an information processing apparatus including a display unit, comprising:
displaying a check screen for checking a progress status of predetermined processing being executed by the information processing apparatus on the display unit;
shifting the information processing apparatus to a locked state in which a user operation performed on the check screen is restricted; and
causing the check screen on which a user operation is restricted to be displayed on the display unit in a case where an instruction for shifting the information processing apparatus to the locked state is received from a user,
wherein on the check screen on which a user operation is restricted, the progress status of the predetermined processing is displayed on a real-time basis.

16. A non-transitory computer-readable storage medium storing a program for causing a computer to execute a method of controlling an information processing apparatus including a display unit,
wherein the method comprises:
displaying a check screen for checking a progress status of predetermined processing being executed by the information processing apparatus on the display unit;
shifting the information processing apparatus to a locked state in which a user operation performed on the check screen is restricted; and
causing the check screen on which a user operation is restricted to be displayed on the display unit in a case where an instruction for shifting the information processing apparatus to the locked state is received from a user,
wherein on the check screen on which a user operation is restricted, the progress status of the predetermined processing is displayed on a real-time basis.
